(19) United States
(12) Patent Application Publication
(10) Pub. No.: US 2009/0224209 A1
(43) Pub. Date: Sep. 10, 2009

(54) PROCESS TO PREPARE A MIXTURE OF HYDROGEN AND CARBON MONOXIDE

(76) Inventors: Jacobus Eilers, Amsterdam (NL); Martin John Fernie, Amsterdam (NL); Herman Pieter Charles Eduard Kuipers, Amsterdam (NL)

Correspondence Address: SHELL OIL COMPANY, P O BOX 2463, HOUSTON, TX, 772522463, US

(21) Appl. No.: 12/274,227

(22) Filed: Nov. 19, 2008

(30) Foreign Application Priority Data
Nov. 19, 2007 (EP) 07121024.9

(51) Int. Cl. C01B 3/36; C09C 1/48

(52) U.S. Cl. 252/373; 422/158

(57) ABSTRACT

A process to prepare a mixture of hydrogen and carbon monoxide from a methane containing gaseous feed by performing the following steps,
(a) performing a partial oxidation by contacting the feed with an oxygen containing gas to prepare a gaseous mixture comprising hydrogen, carbon monoxide, steam, carbon dioxide, methane and soot particles said mixture having an elevated temperature,
(b) passing the gaseous mixture of step (a) through a filter where the soot particles are retained on the filter and a mixture comprising hydrogen, carbon monoxide, carbon dioxide, methane poor in soot is obtained wherein the filter is a ceramic foam filter or a ceramic wall-flow filter, and
(c) converting the retained soot particles at the elevated temperature to carbon oxide.

This application claims the benefit of European Application No. 07121024.9 filed Nov. 19, 2007.

### BACKGROUND

The invention relates to a process to prepare a mixture of hydrogen and carbon monoxide from a methane containing gaseous feed by performing a partial oxidation by contacting the feedstock with an oxygen containing gas to prepare a gaseous mixture comprising of hydrogen, carbon monoxide, steam, carbon dioxide, methane and soot particles.

Such a process is described in US-A-2005/0102901. This publication describes the partial oxidation (POX) of a carbon heavy fuel in a gasification reactor. In this process soot is generated which is converted in a separate reactor. In this separate vessel a bed of spheres of alumina are present which trap the soot particles for a sufficient time for the soot to be gasified. According to this publication 85% of the soot particles of 21 microns in diameter and substantially all particles above 21 micron diameter are removed by this process. Smaller particles, according to the same publication, pass the bed completely.

U.S. Pat. No. 3,868,331 also describes a process wherein a liquid hydrocarbon fuel is partially oxidized at a temperature of 1400° C. at a pressure of 6 MPa. As in US-A-2005/0102901 soot is converted in a separate reactor. This second reactor may be a fluidized bed of so-called Corundum particles or a vessel comprising a number of layers of perforated ceramic bricks.

U.S. Pat. No. 5,653,916 describes a process wherein a natural gas is partially oxidized. When natural gas is partially oxidized soot is also present in the resultant mixture of hydrogen and carbon monoxide. The gasification temperature in such a process is kept at an elevated level to avoid excessive soot formation.

A disadvantage of a partial oxidation process using a gaseous feed, as in the process of U.S. Pat. No. 5,653,916, is that the consumption of oxygen is high in order to maintain a high gasification temperature. There is a desire to perform such processes at a lower oxygen consumption. This desire is explained by the fact that preparing oxygen is a difficult and energy intensive process.

### SUMMARY OF THE INVENTION

The present process aims at providing a process, which can prepare a mixture of hydrogen and carbon monoxide from a methane containing gaseous feed at a lower oxygen consumption.

This aim is achieved by the following process. A process to prepare a mixture of hydrogen and carbon monoxide from a methane containing gaseous feed by performing the following steps,

(a) performing a partial oxidation by contacting the feed with an oxygen containing gas to prepare a gaseous mixture comprising hydrogen, carbon monoxide, steam, carbon dioxide, methane and soot particles said mixture having an elevated temperature,

(b) passing the gaseous mixture of step (a) through a filter where the soot particles are retained on the filter and a mixture comprising hydrogen, carbon monoxide, carbon dioxide, methane poor in soot is obtained wherein the filter is a ceramic foam filter or a ceramic wall-flow filter, and

(c) converting the retained soot particles at the elevated temperature to carbon oxide.

### BRIEF DESCRIPTION OF THE DRAWINGS

FIG. 1 is a cross-sectional view of a reactor suitable for practicing the invention.

FIG. 2 is a graph of soot particle size versus cumulative mass percent.

FIG. 3 is a graph of soot diameter versus filtration efficiency.

FIG. 4 is a graph of flow rate versus pressure drop.

### DETAILED DESCRIPTION

Applicants found that the process according to the invention can be performed at a lower temperature and thus at a lower oxygen consumption than the prior art processes. The resulting higher soot make at these lower temperatures is dealt with in steps (b) and (c). Applicants found that the use of a ceramic foam filter or a ceramic wall-flow filter results in an efficient reduction in soot concentration in the gas. Such an efficiency would not have been achieved when using the soot filters known for treating the partial oxidation product of the liquid hydrocarbon feeds of the prior art processes. With hindsight this can be explained by our finding that the size of soot particles in the process according to the invention is between 0.01 and 1 microns. The ceramic foam filter or ceramic wall-flow filter have been found to have a high filtration efficiency for this size range of particles.

The mixture comprising hydrogen, carbon monoxide, carbon dioxide, methane and which mixture is poor in soot as obtained in step (b) is also referred to as synthesis gas in this specification.

The ceramic foam filter or a ceramic wall-flow filter suitable for use in the process of the present inventions may suitably be the well-known filter designs for removing particulates from exhaust gas generated by a diesel engine.

Suitable ceramic foams are made of a porous refractory material, preferably having a porosity of between 60 and 95% and a pore density of between 40 and 90 pores per inch (ppi), preferably between 50 and 80 ppi. The pores have preferably a monomodalsize distribution. Applicants have found that material having both small and large pores are more prone to clogging. The refractory material is suitably alumina or zirconia, more preferably alumina. Such ceramic foams are described in for example U.S. Pat. No. 7,258,825 and available from for example Vesuvius, a division of the Cookson Group plc and AceChemPack Tower Packing Co. Ltd. Ceramic foams are available as sheets of for example about 1.5 cm thick. In order to increase the flow path length of the gas as it passes the ceramic foam two or more of these foam sheets may be combined into 1 brick by means of an impermeable alumina spray coating sprayed around the vertical sides of the stack of foam sheets. A brick like structure having dimensions of suitably between 100 and 300 cm thickness may thus be obtained. These bricks are suitably used to form the filter as used in step (b). Wall-flow filters are well known from for example the car industry where such filters are used as filters for removing particulates from exhaust gas generated by a diesel engine. Such filters are sometimes referred to in the art as diesel particulate filters. A wall-flow filter typically has a shape of a monolithic honeycomb, the honeycomb having an inlet end and an outlet end, and a plurality of channels extending from the inlet end to the outlet end, the channels having porous walls wherein part of the total number of channels at the inlet end are plugged along a short portion of their lengths, and the remaining part of the cells that are open at the inlet end are plugged at the outlet end along a short portion of their lengths, so that a flowing exhaust gas stream passing through the channels of the honeycomb from the inlet end flows into the open channels, through the channel walls, and out of the filter through the open channels at the outlet end. Suitable wall-flow filters have a channel density of between 100 and 200 channels per square inch. In order to increase the separation efficiency more than one wall-flow filters may be arranged in series. Preferably one wall-flow filter is arranged on top of the next wall-flow filter separated by means of a spacer to allow the gas an easy entrance into the next wall flow-filter.

Suitable wall-flow filters are made of a porous refractory material, preferably having a monomodal pore size distribution. The monomodal pores preferably have a diameter of between 5 and 25 μm, and more preferably 8-14 μm. The refractory material is suitably alumina or zirconia, more preferably alumina because it is more stable. Suitable wall-flow filter designs are described in Structured Catalysts and Reactors 2^{nd} Edition (Moulijn & Cybulski) pages 675-685 and specialist ceramic manufacturing companies such as for example Ceramiques, Techniques & Industrielles s.a can manufacture such filters.

The ceramic foam or a ceramic wall-flow filter preferably comprises a coating of an oxide of a metal selected from the group consisting of manganese, iron, copper, tin, cobalt and cerium. The presence of these oxides catalyze the conversion of the soot particles in the filter itself. The content of these oxides in the filter is preferably between 20 and 60 wt %.

The partial oxidation in step (a) is preferably performed in a vertically elongated reactor vessel as for example described in WO-A-2006097440.

The methane containing gas in step (a) can be obtained from various sources such as natural gas, refinery gas, associated gas or coal bed methane and the like. The gaseous mixture suitably comprises mainly, i.e. more than 90 v/v %, especially more than 94%, C₁₋₄ hydrocarbons, especially comprises at least 60 v/v percent methane, preferably at least 75 volume percent, more preferably at least 90 volume percent. Preferably natural gas or associated gas is used. The gaseous feed of step (a) may comprise a recycle stream as obtained in a downstream process, which uses the synthesis gas as obtained in step (b). An illustrative downstream process is for example a Fischer-Tropsch process. The recycle gas of the Fischer-Tropsch process is the gaseous by-product obtained in the Fischer-Tropsch synthesis which gaseous product comprises methane.

In case a filter is used having an amount of catalytically active metal as described above it may be preferred to remove any sulphur in the methane containing gaseous feed prior to performing step (a) to levels of below 10 ppm, preferably below 0.1 ppm. Such a sulphur removal step may also be preferred if downstream processes are sensitive to sulphur poisoning.

The partial oxidation of step (a) may be performed according to well-known principles. Preferably step (a) is performed in a vertically elongated reactor vessel, wherein the partial oxidation is performed in a multi-channel burner positioned at the top end of the vessel. Preferably the burner fires in a downwardly direction. In step (a) the gaseous feed is contacted with an oxygen containing gas under partial oxidation conditions. Preferably no additional steam is supplied to step (a) or more specifically to the burner. Steam may be present in the methane containing gaseous feed when said feed has been subjected to an optional upstream pre-reforming step. Examples of such a partial oxidation process is the Shell Gasification Process as described in the Oil and Gas Journal, Sep. 6, 1971, pp 85-90 and the processes as described in EP-A-291111, WO-A-9722547, WO-A-9639354 and WO-A-9603345.

The partial oxidation of step (a) is performed in the absence of a catalyst as is the case in the above referred to Shell Gasification Process. In the absence of a catalyst is hereby especially intended to mean in the absence of a downstream reforming catalyst. Such processes are also referred to as non-catalyzed partial oxidation processes. Thus no catalytic conversion takes place between the partial oxidation as performed in the burner of the partial oxidation reactor vessel and the filter of step (b).

The oxygen containing gas may be air (containing about 21 percent of oxygen) and preferably oxygen enriched air, suitably containing up to 100 percent of oxygen, preferably containing at least 60 volume percent oxygen, more preferably at least 80 volume percent, more preferably at least 98 volume percent of oxygen. Oxygen enriched air may be produced via cryogenic techniques, or alternatively by a membrane based process.

The temperature of the oxygen as used in step (a) is preferably greater than 200° C. The upper limit of this temperature is preferably 500° C., more preferably 350° C.

The gaseous mixture of the partial oxidation reaction in step (a) preferably has a temperature of between 1100 and 1500° C., more preferably between 1100 and 1350° C. and even more preferably below 1250° C. The temperature of the synthesis gas obtained in step (b) will be about the same as in step (a) because no cooling preferably takes place between step (a) and step (b). The synthesis gas as obtained in step (b) is cooled. Preferably cooling is performed by directly cooling to a temperature of below 500° C. by indirect heat exchange against evaporating water.

The gaseous mixture of the partial oxidation reaction in step (a) and step (b) preferably has a pressure of between 2 and 10 MPa and preferably between 3 and 10 MPa. The pressure of the gaseous mixture of step (a) is suitably just above the pressure of the synthesis gas of step (b) wherein the difference results from the pressure drop caused by the filter.

The H₂/CO molar ratio of the synthesis gas obtained in step (b) is from 1.5 up to 2.6 and preferably from 1.6 up to 2.2.

Preferably the temperature of the methane containing gaseous feed in step (a) is between 400 and 900° C. Advantageously the temperature is above 600° C. and more preferably above 700° C. and even more preferably between 750 and 900° C. in order to reduce oxygen consumption even further. When the temperature of the methane containing gaseous feed is above 650° C. it is preferred to subject the methane containing gaseous feed to a pre-reformer step before being used in step (a).

The methane containing gaseous feed will have to be increased in temperature to the above-mentioned temperatures before being used as feed in step (a). Increasing the temperature can be performed in a fired furnace or by indirect heat exchange against the synthesis gas after it has passed the ceramic filter in step (b). This also results in a reduction of the synthesis gas temperature and can, partly or wholly, replace the indirect heat exchange against evaporating water as discussed above. Alternatively it is also possible to increase the temperature by blending part of the hot synthesis gas with the pre-reformed gas and perform step (a) using this combined mixture as feed.

Pre-reforming is a well-known technique and has been applied for many years in for example the manufacture of so-called city gas. Suitably the pre-reforming step is performed as a low temperature adiabatic steam reforming process. The gaseous feed to the pre-reforming step is preferably mixed with a small amount of steam and preheated to a temperature suitably in the range 350-700° C., preferably between 350 and 530° C. and passed over a low temperature steam reforming catalyst having preferably a steam reforming activity at temperatures of below 650° C., more preferably below 550° C. The pressure at which the pre-reforming is employed is preferably between 2 and 10 MPa. Preferably the pressure is about in the same range as the pressure at which step (a) is performed. The steam to carbon (as hydrocarbon and CO) molar ratio is preferably below 1 and more preferably between 0.1 and 1.

Suitable catalysts for the low temperature steam pre-reforming are catalyst comprising an oxidic support material, suitably alumina, and a metals of the group consisting of Pt, Ni, Ru, Ir, Pd and Co. Examples of suitable catalysts are nickel on alumina catalyst as for example the commercially available pre-reforming catalysts from Johnson Matthey, Haldor Topsoe, BASF and Süd Chemie or the ruthenium on alumina catalyst as the commercially available catalyst from Osaka Gas Engineering.

The pre-reforming is preferably performed adiabatically. Thus the gaseous feedstock and steam are heated to the desired inlet temperature and passed through a bed of the catalyst. Higher hydrocarbons having 2 or more carbon atoms will react with steam to give carbon oxides and hydrogen. At the same time methanation of the carbon oxides with the hydrogen takes place to form methane. The net result is that the higher hydrocarbons are converted to methane with the formation of some hydrogen and carbon oxides. Some endothermic reforming of methane may also take place. Since the equilibrium at such low temperatures lies well in favour of the formation of methane, the amount of such methane reforming is small. This results in that the product from this stage is a methane-rich gas. The heat required for the reforming of higher hydrocarbons is provided by heat from the exothermic methanation of carbon oxides (formed by the steam reforming of methane and higher hydrocarbons) and/or from the sensible heat of the feedstock and steam fed to the catalyst bed. The exit temperature will therefore be determined by the temperature and composition of the feedstock/steam mixture and may be above or below the inlet temperature. The conditions should be selected such that the exit temperature is lower than the limit set by the de-activation of the catalyst. While some reformer catalysts commonly used are deactivated at temperatures above about 550° C., other catalysts that may be employed can tolerate temperatures up to about 700° C. Preferably the outlet temperature is between 350 and 530° C.

In step (c) the retained soot particles are converted to carbon oxides. This conversion takes place in the pores of the filter material. In this so-called in situ conversion the solid carbon in the soot is converted to gaseous carbon oxides, which carbon oxides are discharged from the filter together with the synthesis gas. Carbon oxides are carbon monoxide and/or carbon dioxide. Without wishing to be bound to the following theory but applicants believe that the carbon in the soot is converted according to the below reactions:

C+H₂O−>CO+H₂

C+CO₂−>2CO

The soot is present in the gaseous mixture as obtained in step (a). The amount of soot will be dependant on the gasification temperature, wherein the lower the temperature the more soot will be present in the gaseous mixture. At the lower end of the temperature range the gaseous mixture may even comprise more than 5000 mg soot per actual m³, at the actual pressure of the gaseous mixture. The soot comprises individual soot particles wherein typically more than 50 wt % of the soot particles have a size of less than 1 micron as measured by a Malvern Mastersizer.

In the non-catalyzed partial oxidation of methane containing gaseous feeds it is desired to minimize the oxygen consumption. In prior art processes, which are operated without performing steps (b) and (c) according to the present invention, a high flame temperature and thus a high temperature of the gaseous mixture are required to avoid significant soot formation. Applicants have now found that one may operate at more moderate temperature conditions and accept soot formation. By performing steps (b) and (c) the increased soot concentration is reconverted to carbon monoxide and hydrogen while simultaneously achieving the advantages of being able to operate at the lower temperature conditions and lower oxygen consumption. This is illustrated by the below table 1. The values in the table are the result of model calculations wherein the temperature of oxygen as fed to the burner is 250° C. and the temperature of the preheated methane gas feed to the burner is 800° C.

TABLE 1

| Temperature | 1200 | 1350 |
|---|---|---|
| Oxygen | 92.3% | 100% |
| consumption (*) | | |
| CO₂ | 2.7 | 3.12 |
| H₂ | 59.8 | 60.4 |
| CO | 31.8 | 32.13 |
| Estimated soot | 17500% | 100% |
| formation (*) | | |

(*) 100% at 1350° C.;

The synthesis gas as obtained by the above process may advantageously be used as feedstock for a Fischer-Tropsch synthesis process, methanol synthesis process, a di-methyl ether synthesis process, an acetic acid synthesis process, ammonia synthesis process or to other processes which use a synthesis gas mixture as feed such as for example processes involving carbonylation and hydroformylation reactions.

Preferably steps (a), (b) and (c) are performed in the same vertically elongated reactor vessel as described above. The filter as used in the present process is very efficient and therefore it has been found possible to locate said filter within the reactor vessel in which step (a) is performed. The filter will be suitably located at a position well below the burner at the base of the vessel. Preferably the filter is positioned such that substantially all of the gaseous mixture in step (b) has to pass the filter material. The vessel is further provided with an outlet for the synthesis gas located in the vessel wall and downstream of the filter. The invention is also directed to a vertically elongated reactor vessel comprising a multi-channel burner positioned at the top end of the vessel and a filter located at a position well below the burner at the base of the vessel, which filter divides the reactor in a larger upper space and a smaller lower space and an outlet located in the vessel wall in the lower space and wherein the filter is a ceramic foam filter or a ceramic wall-flow filter. The preferred filters are as described above.

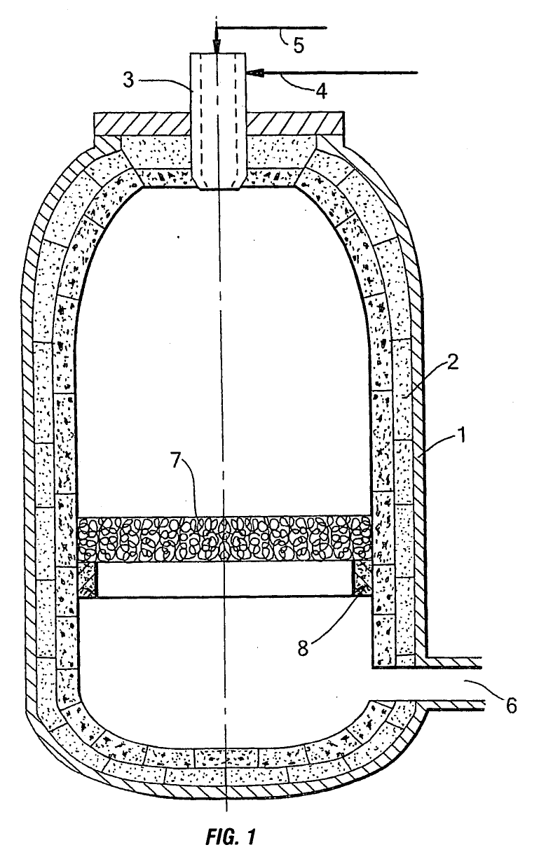

FIG. 1 shows a vertically elongated reactor having a pressure shell 1, a multi-layer refractory lining 2 fixed to the inner wall of pressure shell 1. The reactor is further provided with a downwardly firing burner 3 having supply conduits 4 and 5 for the oxygen containing gas and the methane containing gaseous feedstock respectively Inside the pressure shell 1 a ceramic filter bed 7 is shown being supported by refractory brick support arch 8. The ceramic filter bed 7 may be a number of ceramic foam filters or ceramic wall-flow filters mounted in a special mounting to avoid bypassing of gas around the filter. Also shown is an outlet 6 for synthesis gas. Preferably this outlet 6 is fluidly connected to a waste heat boiler (not shown) where the hot synthesis gas is reduced in temperature against evaporating water as for example described in EP-A-257719.

The invention will be illustrated by the following examples.

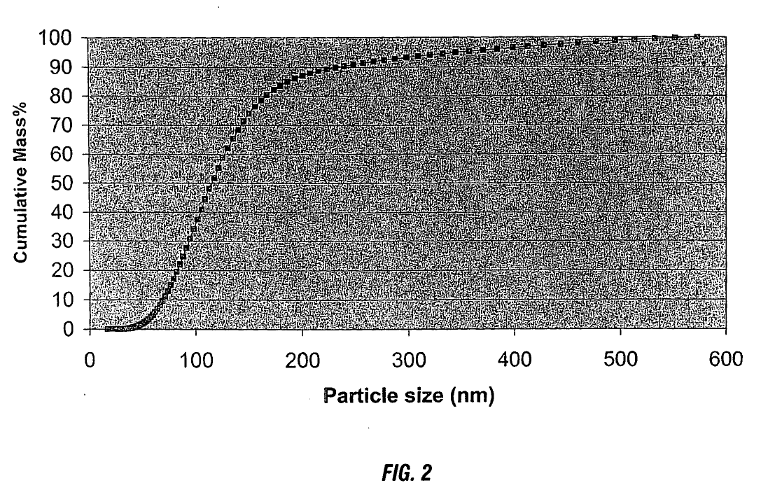

In the examples 1-7 a flow of air having a soot content of 7 mg soot per m³ was used. The soot had a particle size distribution which was for >90 wt % in the range 0-0.3 μm as generated by a Real Soot Generator (RSG) Minicast (Ying AG) as shown in FIG. 2. The tests were also carried out with a soot in the size range of 0-0.6 μm obtained by redispersing soot via an SAG 410 or SAG 440 disperser unit (TOPAS GMBH) and similar results were obtained.

### Comparative Example 1

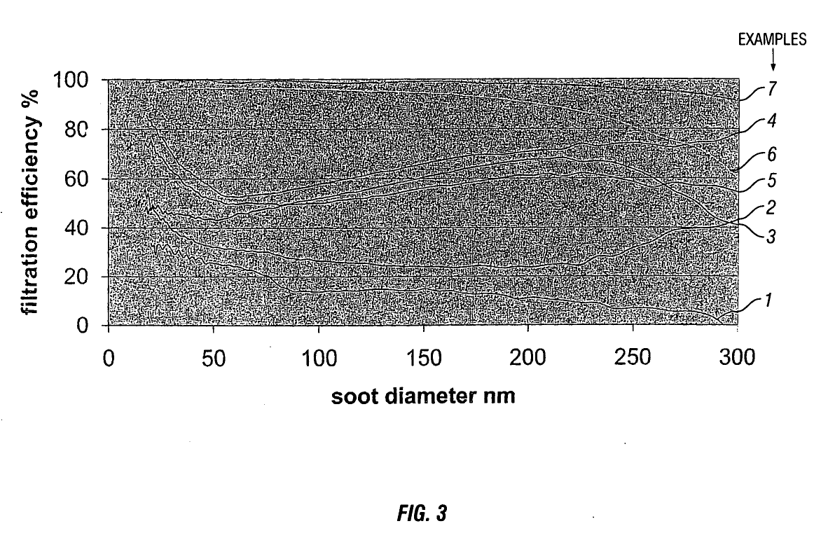

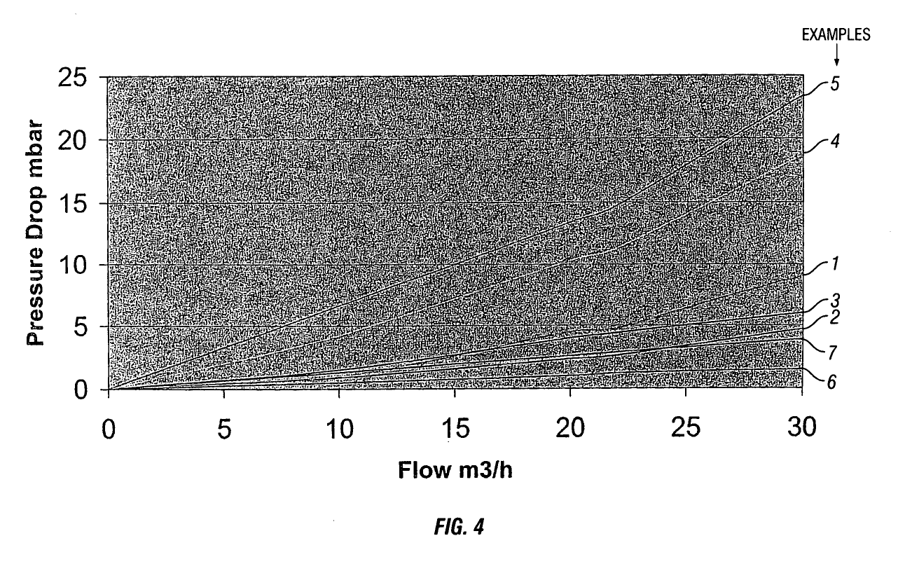

The gas mixture was passed through a bed of alumina spheres at a rate of 21 m³/hour. The bed height was 150 mm. The alumina spheres had the following properties 5 mm diameter, 70-90% porosity, 3 micron median pore diameter. The removal efficiency as a function of particle size is presented in FIG. 3. The pressure drop over the filter as a function of air flow is given in FIG. 4.

### Example 2

Example 1 was repeated except that instead of spheres a bed of alumina foam A was used. The gas rate was 17 m³/hour. The bed height was 145 mm. Alumina foam A had a pore per inch of 50 and the pores were qualified as monomodal. The removal efficiency as a function of particle size is presented in FIG. 3. The pressure drop over the filter as a function of air flow is given in FIG. 4.

### Example 3

Example 2 was repeated with an alumina foam B having a pore per inch of 65 and the pores were qualified as monomodal. The removal efficiency as a function of particle size is presented in FIG. 3. The pressure drop over the filter as a function of air flow is given in FIG. 4.

### Example 4

Example 3 was repeated with a bed height of 300 mm. The removal efficiency as a function of particle size is presented in FIG. 3. The pressure drop over the filter as a function of air flow is given in FIG. 4.

### Example 5

Example 2 was repeated with an alumina foam B having a pore per inch of 70 and the pores were qualified as monomodal. The removal efficiency as a function of particle size is presented in FIG. 3. The pressure drop over the filter as a function of air flow is given in FIG. 4.

### Example 6

The gas mixture was passed through an alumina wall flow filter having 200 channels per square inch. The walls of the channels have monomodal pores of 10.5 μm. The gas rate was 35 m³/hour. The filter height was 150 mm. The removal efficiency as a function of particle size is presented in FIG. 3. The pressure drop over the filter as a function of air flow is given in FIG. 4.

### Example 7

Example 6 was repeated wherein two wall flow filters were applied in series. The removal efficiency as a function of particle size is presented in FIG. 3. The pressure drop over the filter as a function of air flow is given in FIG. 4.

Examples 1-7 show that foams have a better separation efficiency than spheres or rings and that wall flow filters have better separation efficiency than foams. The pressure drop over wall flow filters is the lowest while foams having a large ppi had the largest pressure drop.

### Example 8

A cylindrical piece of alumina foam impregnated with 100 micrograms of soot and mounted in a glass tube was heated in an inert atmosphere in an oven to 1200° C. at which point an inert nitrogen gas flow with 10 vol % H₂O content was passed through the foam. By monitoring the exit gas composition it was determined that the soot reacted with H₂O to form CO and the reaction took 7.5 minutes to completely gasify all the soot. This shows that soot may regasifiy by contact with the synthesis gas at the operating temperatures of step (c) when sufficient soot residence time is experienced by capturing the soot in a foam filter.

1. A process to prepare a mixture of hydrogen and carbon monoxide from a methane containing gaseous feed by performing the following steps,
(a) performing a partial oxidation by contacting the feed with an oxygen containing gas to prepare a gaseous mixture comprising hydrogen, carbon monoxide, steam, carbon dioxide, methane and soot particles said mixture having an elevated temperature,
(b) passing the gaseous mixture of step (a) through a filter where the soot particles are retained on the filter and a mixture comprising hydrogen, carbon monoxide, carbon dioxide, methane poor in soot is obtained wherein the filter is a ceramic foam filter or a ceramic wall-flow filter, and
(c) converting the retained soot particles at the elevated temperature to carbon oxide.

2. A process according to claim 1, wherein the temperature of the gaseous mixture as obtained in step (a) as it passes the filter in step (b) has a temperature of between 1100 and 1350° C.

3. A process according to claim 1, wherein the temperature of the gaseous mixture as obtained in step (a) as it passes the filter in step (b) has a temperature of between 1100 and 1250° C.

4. A process according to claim 1, wherein the gaseous mixture as obtained in step (a) as it passes the filter in step (b) has a pressure of between 2 and 10 MPa.

5. A process according to claim 1, wherein more than 50 wt % of the soot particles have a size of less than 1 micron as measured by a Malvern Mastersizer.

6. A process according to claim 1, wherein the filter is a ceramic foam composed of a porous refractory material having a pore density of between 50 and 80 pores per inch and a porosity between 60% and 95%.

7. A process according to claim 6, wherein the refractory material is alumina.

8. A process according to claim 1, wherein the filter is a ceramic wall-flow filter made of a refractory material having monomodal pores of a diameter of between 5 and 25 μm.

9. A process according to claim 8, wherein the refractory material is alumina.

10. A process according to claim 1, wherein steps (a), (b) and (c) are performed in the same vertically elongated reactor vessel, wherein the partial oxidation in step (a) is performed in a multi-channel burner positioned at the top end of the vessel and step (b) and (c) are performed in a filter located at a position below the burner and wherein the vessel is further provided with an outlet for the mixture of hydrogen and carbon monoxide gas located in the vessel wall and downstream of the filter.

11. A process according to claim 1, wherein the methane containing gaseous feed in step (a) has a temperature of between 400 and 900° C. and the oxygen containing gas has a temperature of between 200 and 350° C. before being subjected to the partial oxidation in step (a) and wherein the methane containing gaseous feed has been subjected to a pre-reformer step before being used in step (a).

12. A vertically elongated reactor vessel comprising a multi-channel burner positioned at the top end of the vessel and a filter located at a position below the burner, which filter divides the reactor into an upper space and a lower space and an outlet located in the vessel wall in the lower space and wherein the filter is a ceramic foam or a ceramic wall-flow filter.

13. A reactor according to claim 12, wherein the filter is a ceramic foam filter composed of alumina having a pore density of between 50 and 80 pores per inch and a porosity between 60% and 95%.

14. A reactor according to claim 12, wherein the filter is a ceramic wall-flow filter made of alumina having monomodal pores of a diameter of between 5 and 25 μm.
